(19) United States
(12) Patent Application Publication
(10) Pub. No.: US 2026/0007143 A1
(43) Pub. Date: Jan. 8, 2026

(54) COLD BREW COFFEE PROCESS

(71) Applicant: Stone Bros. Inc., Baker City, OR (US)

(72) Inventors: Jason G. Stone, Baker City, OR (US); Philip G. Stone, Baker City, OR (US)

(21) Appl. No.: 18/752,197

(22) Filed: Jun. 24, 2024

Related U.S. Application Data
(63) Continuation of application No. PCT/US2022/053885, filed on Dec. 22, 2022.
(60) Provisional application No. 63/292,921, filed on Dec. 22, 2021.
(60) Provisional application No. 63/302,644, filed on Jan. 25, 2022.

(51) Int. Cl. A23F 5/26; A23F 5/32; B01D 36/02

(52) U.S. Cl. CPC A23F 5/26; A23F 5/32; B01D 36/02

(57) ABSTRACT

Processes and technologies related to cold brew coffee. The processes and technologies may include cold brewing coffee at certain concentrations, duration, and temperatures. The processes and technologies may include filtering cold brewed coffee through various filtration methods, and freeze drying the filtered cold brewed coffee. The processes may include adjusting the concentration of the cold brewed coffee prior to freeze drying.

### RELATED APPLICATION

This application claims benefit of priority to U.S. Provisional Patent Application Ser. No. 63/292,921, filed on Dec. 22, 2021, titled COLD BREW COFFEE PROCESS and to U.S. Provisional Patent Application Ser. No. 63/302,644, filed on Jan. 25, 2022, titled COLD BREW COFFEE PROCESS, both of which are incorporated herein by reference in their entirety for all purposes.

### INFORMATION

Unless otherwise indicated herein, the approaches described in this section are not prior art to the claims in this application and are not admitted to be prior art by inclusion in this section.

Brewing coffee may include a variety of methods. One method may include using hot water, where the hot water may be added to roasted and ground coffee beans. After a period of time, the mixture of the ground coffee and the hot water may become brewed coffee.

Another method may include using cold water, where the cold water may be added to roasted and ground coffee beans. After a period of time allowing the mixture of the ground coffee and the cold water to steep, cold brewed coffee may result.

It may be appreciated that the above example methods may include various processes to result in coffee having different tastes and/or flavors (e.g., variety of blends, strengths, gourmet ranges, etc.).

All subject matter discussed in this Information section of this document is not necessarily prior art and may not be presumed to be prior art simply because it is presented in this Information section. Plus, any reference to any prior art in this description is not, and should not be taken as, an acknowledgement or any form of suggestion that such prior art forms parts of the common general knowledge in any art in any country. Along these lines, any recognition of problems in the prior art discussed in this Information section or associated with such subject matter should not be treated as prior art, unless expressly stated to be prior art. Rather, the discussion of any subject matter in this Information section should be treated as part of the approach taken towards the particular problem by the inventor(s). This approach in and of itself may also be inventive.

### SUMMARY

Described herein are various illustrative systems and methods for improved cold brewed coffee.

Some example methods may include using roasting coffee beans to a predetermined roasting level. The roasted coffee beans may be ground to a predetermined coarseness. The method may include transferring the ground coffee to a brewing container. Water may be provided a first predetermined temperature to the brewing container having the ground coffee for brewing. The method may include agitating the water and ground coffee mixture for a predetermined period of time and at predetermined temperature brewing the coffee. The method may include filtering the brewed coffee through a first filter, where the first filter may be of a metallic type filter. The method may include filtering the coffee through a second filter, where the second filter may be of a fiber based filter. Additionally, the method may include filtering the coffee through a third filter, where the third filter may be of a pressure plate type filter. The filtered coffee may be freeze dried, where the freeze dried coffee may be processed facilitate reconstituting.

The foregoing summary is illustrative only and not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 illustrates a process of cold brewing and processing cold brewed coffee in accordance with various embodiments.

FIG. 2 illustrates an example freeze dryer device, which may be utilized in various embodiments.

FIG. 3 illustrates an example reverse osmosis device, which may be utilized in various embodiments.

FIG. 4 illustrates simplified example of a distilling device, which may be utilized in various embodiments.

FIG. 5 illustrates an operational flow for brewing cold coffee in accordance with various embodiments as described herein.

FIG. 6 illustrates an example computer program product, arranged in accordance with at least some embodiments described herein.

FIG. 7 is a block diagram illustrating an example computing device 700, such as might be embodied by a person skilled in the art, which is arranged in accordance with at least some embodiments of the present disclosure.

### DETAILED DESCRIPTION

The following description sets forth various examples along with specific details to provide a thorough understanding of claimed subject matter. It will be understood by those skilled in the art after review and understanding of the present disclosure, however, that claimed subject matter may be practiced without some or more of the specific details disclosed herein. Further, in some circumstances, well-known methods, procedures, systems, components and/or circuits have not been described in detail in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

The disclosure is drawn, inter alia, to methods, apparatus, and systems related to preparation of cold brewed coffee for freeze drying.

Prior to turning to the Figures, one or more non-limiting example scenarios of utilization of various embodiments may be described. It will be appreciated that some embodiments may include methods and/or processes. Additionally, it will be appreciated that some embodiments may include apparatus and/or devices.

In one non-limiting example scenario, a processes of brewing cold brew coffee may include acquiring raw coffee beans. The raw coffee beans may be of organic designation standard/certification. Additionally, in one example, the raw coffee beans may be sourced adhering to fair trade standards (e.g., an organization such as, but not limited to, Fairtrade International). In another example, the raw coffee beans may be sourced having an organic certification from a variety of organic certification organizations such as, but not limited to, a United States Department of Agriculture (USDA), members of the International Federation of Organic Agriculture Movements (IFOAM), etc.

Continuing with the non-limiting scenario, the process may include roasting the raw coffee beans. In one example, the raw coffee beans may be of a predetermined amount such as, but not limited to, approximately 60 pounds (lbs.). In one example, the raw coffee beans may be roasted to a medium degree such as, but not limited to substantially full City Roast. The example process may include grinding the roasted coffee beans to a predetermined grind level. In one example, the predetermined grind level may be of a substantially coarse grind. An example of a coarse grind may be a coarse grind setting utilizing a machine such as, but not limited to, a Ditting grinder machine available from Hemro International AG of Bachenbulach, Switzerland. In the example of utilizing the Ditting machine, the Ditting machine may be of a burr wheel grinder type.

The example process may include transferring the ground coffee into a container. The container may be a metal type container such as, but not limited to, a stainless-steel container. The transferring of the ground coffee may be substantially immediate after the grinding is complete (i.e., reducing the amount of exposure of the ground coffee to air). In one example, the container may be of a predetermined volume. For example, the container may be configured to hold approximately 165 gallons of volume. In one example, the container may be configured to brew coffee such as, but not limited to, a coffee brewing container available from Coffee Works of Coeur d′Alene, Idaho. Additionally, the container may be of a variety of types of material such as, but not limited to, glass, plex-glass, copper, wood, etc. Accordingly, the claimed subject matter is not limited in this respect.

In the example process, water may be provided into the container having the ground coffee, where the water may be at a predetermined temperature. In one example, the water may be tap water from the cold water valve of a public water system. In another example, the origin of the water may be cold tap water from the public water system of Baker City, Oregon. The volume of water may be based, at least in part, on the amount of ground coffee. For example, the volume of water may be approximately twice the weight of the ground coffee. In one example, the weight of the coffee may be approximately 60 lbs., and accordingly, the volume of water may be approximately 120 gallons.

Continuing with the non-limiting example process, the process may include agitating the mixture in the container having the water and coffee grounds, for a predetermined period of time. In one example, the predetermined period of time may be approximately 24 hours. In another example, the mixture may be agitated at approximately room temperature (i.e., approximately 60 degrees to 70 degrees Fahrenheit). In one example, the agitation may be provided by a mixing device, which may be included with the container (i.e., an agitating motor and arm, which may be included with the container).

After the predetermined period of time (e.g., approximately 24 hours), the agitated mixture may be referred to as brewed coffee having the coffee grounds. The brewed coffee having the coffee grounds may be passed through a first filter. In one example, the first filter may be included as part of the container (e.g., at a bottom end of the container). For example, the first filter may be a metal type filter such as, but not limited to, a metal mesh. The metal mesh may be included at the bottom of the container, and after the predetermined time period, the brewed coffee having the coffee grounds may be passed through metal mesh filter. The brewed coffee having the coffee grounds may be passed through the metal mesh filter, where the metal mesh filter may facilitate filtering of substantially most of the coffee grounds resulting in a first filtered coffee.

The process may include transferring the first filtered coffee to a second filter. For example, the first filtered coffee may be transferred to a second filter utilizing a variety of transfer methods such as, but not limited to, a pump device. The second filter may be disposed within a container (e.g., after pump container). In one example, the after pump container may have a tall substantially cylindrical type of shape. In one example, the after pump container may be made of a metal such as, but not limited to, stainless steel. These types of stainless steel material may be utilized in the food industry. In one example, the second filter may be a fabric type filter. The fabric type filter included in the after pump container may comprise of a micro fiber sock type filter. The micro fiber sock type filter may be configured to substantially filter the coffee grounds that the first filter may have missed (i.e., substantially solid material that may have passed through the first filter) resulting in a second filtered coffee. Non-liquid material (e.g., coffee grounds, sediment, etc.) may have been substantially removed from the second filtered coffee.

In some example processes, the process may include pumping the second filtered coffee to a third filter. In one example, the third filter may be a plate type filter. The plate type filter may include one or more plate type filters. In some examples, the filters may have a rating of nominal or absolute. These types of filters may have pores that may be measured in microns ranging from 5, 3, 2, 1, and 0.45 microns. In one example, the third filter may be a filter system that may be used in wine processing. Accordingly, some example standards may be adopted and utilized from the wine processing such as, but not limited to, filter flow rates.

For example, a plate filter may have a dimension such as, but not limited to, approximately 20×20 centimeter (cm). The example of a 20×20 cm filter pad may be configured to facilitate a flow rate between approximately 10 and 15 gallons for the filter. In this example, a filter system having 10 plate filters of 20×20 cm filter pads may facilitate a flow of approximately 100 to 150 gallons. These flow rates may be considered to be relative estimates because various factors may affect the flow rates. One example of a filter system that may be used in wine processing may be filter systems available from Buon Vino Manufacturing of Cambridge, Ontario. The resulting third filtered coffee may be substantially free of solid particles such as, but not limited to, coffee grounds, sediment, and other types of particulates resulting in substantially liquid coffee.

The example plate filter of approximately 20×20 cm is but one example dimensions of a plate type filter. It should be appreciated the dimensions of the plate type filter may include a wide range of sizes such as, but not limited to, 40×40 cm. Additionally, the shape of the plate type filter may include varying shapes such as, but not limited to, substantially rectangular, substantially square, substantially circular, and so forth. Accordingly, the claimed subject matter is not limited in these respects.

In some example processes, the substantially liquid coffee (i.e., liquid coffee after the third filter) may be purified. One example of purification may include distilling the substantially liquid coffee. Distilling the substantially liquid coffee may include distilling the substantially liquid coffee to no less than approximately 22% of its original liquid volume. The distilling may be performed subsequent to the filtering process (i.e., right after the filtering processes described above).

The distilling process may include a wide variety of purification methodologies, which may be utilized to purify compounds with different boiling points such as, but not limited to, distilling processes utilized in alcohol distillation, simple distillation, complex distillation (e.g., distillation involving two or more distillation processes), static distilling, dynamic (e.g., rotational) distilling, and so forth. Accordingly, the claimed subject matter is not limited in this respect.

In some examples processes, the process may include, subsequent to the brewing process and/or the filtration process, further filtering of the substantially liquid coffee. In this example, the substantially liquid coffee, subsequent to the brewing process and/or the filtration process, may be filtered utilizing a filter configured to facilitate reverse osmosis (e.g., a reverse osmosis filter). In the example of utilizing a reverse osmosis filter, the process may include a configuration to facilitate travel of the filtered coffee through the reverse osmosis filter by having the substantially liquid coffee travel through one side of a reverse osmosis filter housing and out another side of the reverse osmosis filter housing. This example configuration may facilitate the splitting of the filtered coffee into two or more constituent parts such as, but not limited to, a substantially concentrated coffee and a substantially purified water.

In some examples, the process including the reverse osmosis filter may be configured to be recursive (i.e., repeated) to facilitate achieving a variety of concentrations. For example, the reverse osmosis filter may be utilized in a repeated manner to facilitate achieving approximately 50 percent concentration (i.e., removing approximately 50 percent of water from the liquid coffee resulting in a concentrated coffee). The concentrated coffee may be freeze dried as described below.

Some non-limiting examples of a filter, which may be configured to be a reverse osmosis filter may be shown below and may be available from Vertex Water Products of Montclair, California.

In some example processes, the process may include preparing the substantially liquid coffee for freeze drying. The preparation may include exposing the substantially liquid coffee to an inert gas. After preparation, the substantially liquid coffee may be freeze dried. In some examples, the freeze drying process may be utilized subsequent to the purification process (i.e., subsequent to distillation). The freeze drying may be facilitated by a variety of methods. For example, the freeze drying may be facilitated by freeze drying units ranging from residential (i.e., home) freeze drying units to commercial (i.e., industrial) freeze drying units. An example of some freeze drying method may include freeze drying devices such as those available from Harvest Right, LLC of North Salt Lake, Utah.

In some example processes, the process may include packaging the freeze dried coffee in a predetermined manner. For example, the freeze dried coffee may be packaged to facilitate reconstituting at a ratio of approximately 1 teaspoon to approximately 12 ounces of hot or cold water resulting in a reconstituted coffee. As a result, the reconstituted coffee may have a flavor contemplated within the disclosed subject matter.

In some example processes, the process may include a variety of additives such as, but not limited to, sugar, milk, cream, flavoring syrups, spices, artificial flavorings, artificial sugars, substitute sweeteners, herbs, etc. The variety of additives may be in a variety of forms such as, but not limited to, dried, wet, concentrated, etc. Accordingly, the claimed subject matter is not limited in these respects.

In some example processes, the methods, process, systems may be facilitated by various industrial means such as, but not limited to, computer controlled, machine automation, artificial intelligence, machine learning, etc. Accordingly, the claimed subject matter is not limited in these respects.

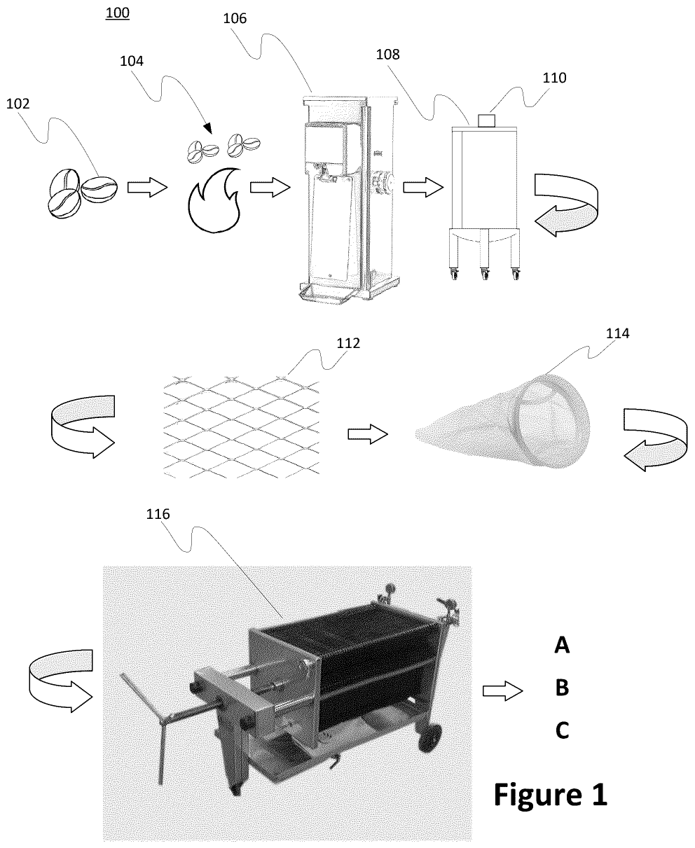

Turning now to FIG. 1, FIG. 1 illustrates a process of cold brewing and processing cold brewed coffee in accordance with various embodiments. In FIG. 1, a cold brew coffee process 100 may include selecting 102. Once selected, the cold brew coffee process 100 may include roasting 104 the raw coffee beans. In FIG. 1, the cold brew coffee process 100 may include griding 106 the roasted coffee beans. The ground coffee beans may be transferred 108 to a container. Water at a predetermined temperature may be provided into the container to facilitate the cold brewing process. As part of the cold brewing process, the mixture of the coffee grounds and the water may be agitated 110.

In the cold brew coffee process 100 after a predetermined time, the brewed coffee in the container may be filtered through a first filter 112. As previously described, in one embodiment, filtering through the first filter 112 may include utilizing a metal type filter. Additionally, the first filter may be included as part of the container used in the brewing process 108. Subsequent to the first filtering 112, the coffee may be filtered a second time through a second filter 114.

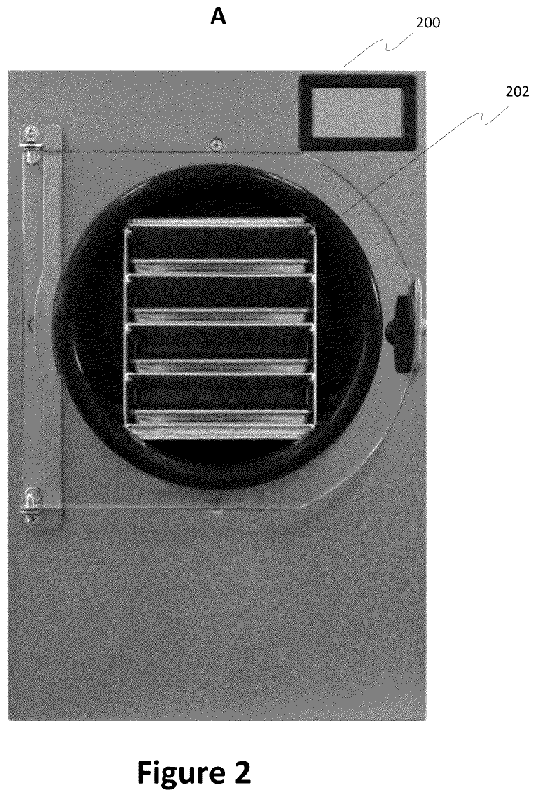

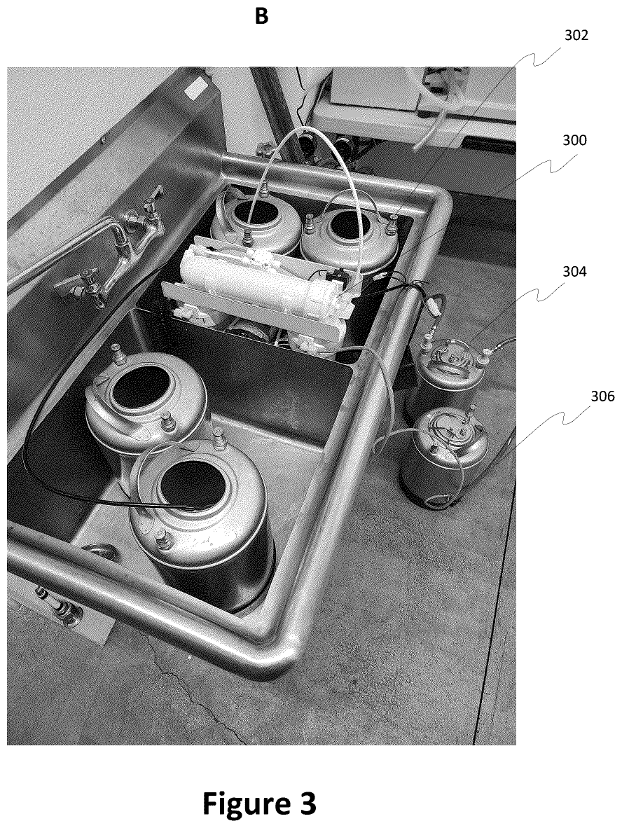

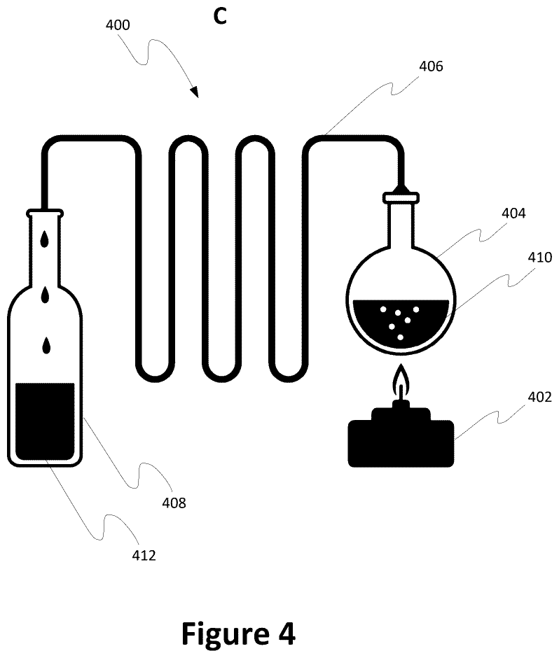

In an embodiment shown in FIG. 1, the cold brew coffee process 100 may include filtering the coffee through a third filter 116. The third filtering 116 may include utilizing a plate type filter. As shown in FIG. 1, after the third filtering 116, the cold brew coffee process 100 may include freeze drying A as shown in FIG. 2. In one embodiment, prior to freeze drying A, the cold brew coffee process 100 may include processing the coffee utilizing a reverse osmosis process B as shown in FIG. 3. In another embodiment, the prior to freeze drying A, the cold brew coffee process 100 may include processing the coffee utilizing a distilling process C as shown in FIG. 4.

It should be appreciated that the cold brew coffee process 100 may be shown without various intervening processes and actions. For example, various methods of transferring between the processes may include pumps, buckets, sacks, etc., which are not shown in order to not obscure the claimed subject matter. Accordingly, the claimed subject matter is not limited in these respects.

It should be appreciated that the filtering processes may be altered. For example, the third filtering 116 may be omitted based, at least in part, on a desired level of filtering. Alternatively, the first filtering 112 may include utilizing a fiber and/or plate type filtering. Accordingly, the claimed subject matter is not limited in these respects.

In the cold brew coffee process 100 of FIG. 1, the reverse osmosis process B and the distilling process C may be interchangeable and/or combined. For example, the reverse osmosis process B may be used in conjunction with the distilling process C. Accordingly, the claimed subject matter is not limited in this respect.

In some examples, the various component processes of the coffee process 100 shown in FIG. 1 may be performed in separate locations in their constituent parts and may be combined. In some examples, the coffee process 100 may be performed in a single location (e.g., at a factory, where raw coffee beans may be processed its product. In some examples, the coffee process 100 may include growing the coffee beans. In another example, the coffee process 100 may include growing the coffee beans to selling the freeze dried coffee (e.g., growing the coffee beans to serving the cold brew coffee).

FIG. 2 illustrates an example freeze dryer device, which may be utilized in various embodiments. In FIG. 2, the freeze drying process A may be facilitated by a freeze drying device 200. In FIG. 2, the freeze drying device 200 may include a number of freeze drying trays 202. The cold brew coffee process 100 of FIG. 1 may include utilizing the freeze drying device 200 after one or more filtering processes 112, 114, and/or 116. The freeze drying device 200 may include a wide variety of freeze drying devices such as, but not limited to, home, industrial, etc. Accordingly, the claimed subject matter is not limited in this respect.

FIG. 3 illustrates an example reverse osmosis device, which may be utilized in various embodiments. In FIG. 3, the reverse osmosis process B may be facilitated by utilizing a reverse osmosis device 300. In FIG. 3, the reverse osmosis device 300 may include a number of containers 302, which may be utilized to receive various material from the reverse osmosis device 300. As shown, the reverse osmosis device 300 may include one or more enclosed containers 304, which may be utilized to receive and/or pump various material/liquid to/from the reverse osmosis device 300. The reverse osmosis device 300 may include one or more various hoses 306, which may be utilize to transfer (e.g., pump) various material/liquid to/from the various components of the reverse osmosis device 300. Subsequent to the reverse osmosis process B, the coffee may be freeze dried A.

It should be appreciated that the reverse osmosis device 300 may include a wide variety of reverse osmosis devices and configurations to achieve a wide variety of concentrations. Accordingly, the claimed subject matter is not limited in this respect.

FIG. 4 illustrates simplified example of a distilling device, which may be utilized in various embodiments. In FIG. 4, the distilling process C may be facilitated by utilizing a distilling device 400. In FIG. 4, the distilling device 400 may include a heat source 402, a heating container 404, a transport connector 406, and a collector container 408. As shown, the distilling device 400 may be utilized to heat coffee 410 in the heating container 404. The coffee 410 may evaporate and be transported via the transport connector 406 to the collector container 408. As it may be appreciated, during transportation of the evaporated coffee from the heating container 404 to the collector container 408, the coffee 404 may recondense into a distilled coffee 412. Subsequent to the distilling process C, the coffee may be freeze dried A.

As previously mentioned, the reveres osmosis process B and the distilling process C may be interchangeable. Accordingly, the claimed subject matter is not limited in this respect.

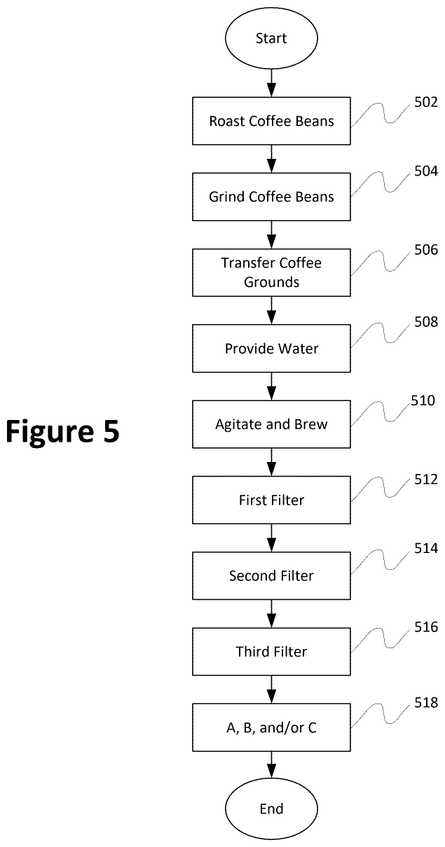

FIG. 5 illustrates an operational flow for brewing cold coffee in accordance with various embodiments as described herein. In some portions of the description, illustrative implementations of the method are described with reference to the elements depicted in FIGS. 1-4. However, the described embodiments are not limited to these depictions.

Additionally, FIG. 5 employs block diagrams to illustrate the example methods detailed therein. These block diagrams may set out various functional block or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in one figure may be operated using techniques discussed with respect to another figure. Additionally, in some examples, the actions shown in these figures may be operated using parallel processing techniques. The above described, and other not described, rearrangements, substitutions, changes, modifications, etc., may be made without departing from the scope of the claimed subject matter.

In some examples, operational flow 500 may be employed as part of cold brew coffee brewing system as described herein. Beginning at block 502 (“Roast Coffee Beans”), raw coffee beans may be roasted, where the roasting may be to a predetermined roast (e.g., cinnamon roast, blonde roast, light city roast, half city roast, New England roast, American roast, city roast, breakfast roast, full city roast, continental roast, high roast, New Orleans roast, espresso roast, Viennese roast, European roast, French roast, Italian roast, etc.).

Continuing from block 502 to block 504 (“Grind Coffee Beans”), the roasted coffee beans may be ground to a predetermined coarseness (e.g., fine, medium, coarse, etc.).

Continuing from block 504 to block 506 (“Transfer Coffee Grounds”), the ground coffee beans may be transferred to a container (e.g., a coffee brewing container).

Continuing from block 506 to block 508 (“Provide Water”), a predetermined volume of water at a predetermined temperature may be provided into the container having the coffee grounds (e.g., coffee brewing container).

Continuing from block 508 to block 510 (“Agitate and Brew”), a predetermined volume of water at a predetermined temperature may be provided into the container having the coffee grounds (e.g., coffee brewing container).

Continuing from block 510 to block 512 (“First Filter”), the brewed coffee may be filtered through a first filter (e.g., may be included as part of the container).

Continuing from block 512 to block 514 (“Second Filter”), after the passing through the first filter, the coffee may be filtered through a second filter (e.g., a fiber type filter).

Continuing from block 514 to block 516 (“Third Filter”), after the passing through the second filter, the coffee may be filtered through a third filter (e.g., a plate filter).

Continuing from block 516 to block 518 (“A, B, and/or C”), after the passing through the third filter, the coffee may be processed in accordance with various embodiments disclosed herein. For example, in one embodiment, the coffee may be freeze dried after the third filter. In another embodiment, the coffee may be distilled after the third filter and subsequently, freeze dried. In yet another embodiment, the coffee may be processed using a reverse osmosis methodology to adjust the concentration of coffee and subsequently freeze dried.

It should be appreciated that in the operational flow described above, after brewing, the coffee may be filtered in a variety of manners such as, but not limited to, plate type filter prior to the fiber type filter. Additionally, the transportation of the coffee may be facilitated by a variety of manners such as, but not limited to, hand carry, a pump, gravity feed, etc. Accordingly, the claimed subject matter is not limited in this respect.

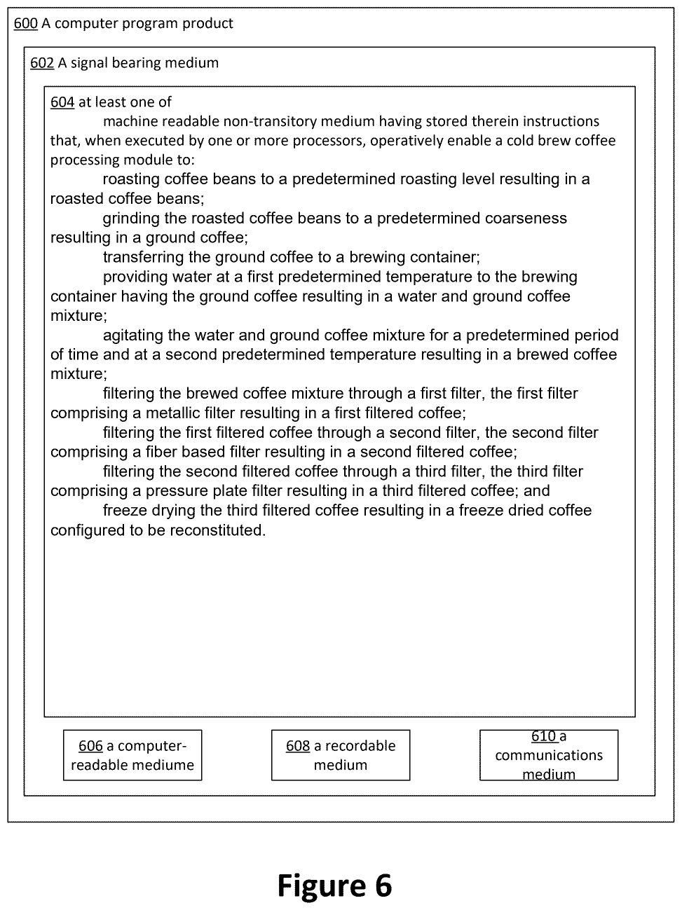

In general, the operational flow described with respect to FIG. 5 and elsewhere herein may be implemented as a computer program product, executable on any suitable computing system, or the like. For example, a computer program product for brewing cold brew coffee may be provided. Example computer program products may be described with respect to FIG. 6 and elsewhere herein.

FIG. 6 illustrates an example computer program product 600, arranged in accordance with at least some embodiments described herein. Computer program product 600 may include machine readable non-transitory medium having stored therein instructions that, when executed, cause the machine to facilitate brewing and processing of cold brew coffee according to the processes and methods discussed herein. Computer program product 600 may include a signal bearing medium 602. Signal bearing medium 602 may include one or more machine-readable instructions 604 which, when executed by one or more processors, may operatively enable a computing device to provide the functionality described herein. In various examples, the devices discussed herein may use some or all of the machine-readable instructions.

In some examples, the machine readable instructions 604 may include a cold brew coffee processing module. In some examples, the machine readable medium 604 may facilitate the cold brew coffee processing module to roast coffee beans to a predetermined roasting level, grind; the roasted coffee beans to a predetermined coarseness, transfer the ground coffee to a brewing container, provide water at a first predetermined temperature to the brewing container having the ground coffee, and agitate the water and ground coffee mixture for a predetermined period of time.

In some examples, the machine readable medium 604 may facilitate the cold brew coffee processing module to filter the brewed coffee mixture through a first filter, filter the first filtered coffee through a second filter, filter the second filtered coffee through a third filter, and freeze dry the third filtered coffee.

In some implementations, signal bearing medium 602 may encompass a computer-readable medium 606, such as, but not limited to, a hard disk drive, a Compact Disc (CD), a Digital Versatile Disk (DVD), a Universal Serial Bus (USB) drive, a digital tape, memory, etc. In some implementations, the signal bearing medium 602 may encompass a recordable medium 608, such as, but not limited to, memory, read/write (R/W) CDs, R/W DVDs, etc. In some implementations, the signal bearing medium 602 may encompass a communications medium 610, such as, but not limited to, a digital and/or an analog communication medium (e.g., a fiber optic cable, a waveguide, a wired communication link, a wireless communication link, etc.). In some examples, the signal bearing medium 602 may encompass a machine readable non-transitory medium.

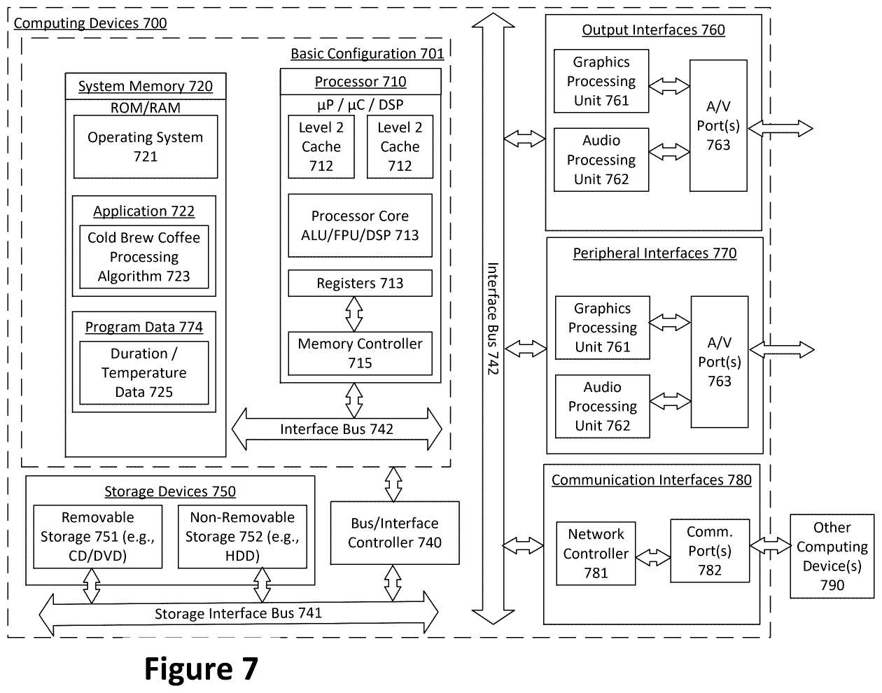

In general, the methods described with respect to FIG. 6 and elsewhere herein may be implemented in any suitable computing system. Example systems may be described with respect to FIG. 7 and elsewhere herein. In general, the system may be configured to facilitate a cold brew coffee processing module in accordance with various embodiments.

FIG. 7 is a block diagram illustrating an example computing device 700, such as might be embodied by a person skilled in the art, which is arranged in accordance with at least some embodiments of the present disclosure. In one example configuration, computing device 700 may include one or more processors 710 and system memory 720. A memory bus 730 may be used for communicating between the processor 710 and the system memory 720.

Depending on the desired configuration, processor 710 may be of any type including but not limited to a microprocessor (UP), a microcontroller (C), a digital signal processor (DSP), or any combination thereof. Processor 710 may include one or more levels of caching, such as a level one cache 711 and a level two cache 712, a processor core 713, and registers 714. The processor core 713 may include an arithmetic logic unit (ALU), a floating point unit (FPU), a digital signal processing core (DSP Core), or any combination thereof. A memory controller 715 may also be used with the processor 710, or in some implementations the memory controller 715 may be an internal part of the processor 710.

Depending on the desired configuration, the system memory 720 may be of any type including but not limited to volatile memory (such as RAM), non-volatile memory (such as ROM, flash memory, etc.) or any combination thereof. System memory 720 may include an operating system 721, one or more applications 722, and program data 724. Application 722 may include cold brew coffee processing algorithm 723 that is arranged to perform the functions as described herein including the functional blocks and/or actions described. Program Data 724 may include, among other information described, brewing and filtering criterion (e.g., temperature, duration, agitation, coarseness, roast, filtration, etc.) 725 for use with the cold brew coffee processing algorithm 723. In some example embodiments, application 722 may be arranged to operate with program data 724 on an operating system 721 such that implementations of cold brew coffee processing module may be provided as described herein. For example, apparatus described in the present disclosure may comprise all or a portion of computing device 700 and be capable of performing all or a portion of application 722 such that facilitating cold brew coffee processing as described herein. This described basic configuration is illustrated in FIG. 7 by those components within dashed line 701.

Computing device 700 may have additional features or functionality, and additional interfaces to facilitate communications between the basic configuration 701 and any required devices and interfaces. For example, a bus/interface controller 740 may be used to facilitate communications between the basic configuration 701 and one or more data storage devices 750 via a storage interface bus 741. The data storage devices 750 may be removable storage devices 751, non-removable storage devices 752, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 720, removable storage 751 and non-removable storage 752 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 700. Any such computer storage media may be part of device 700.

Computing device 700 may also include an interface bus 742 for facilitating communication from various interface devices (e.g., output interfaces, peripheral interfaces, and communication interfaces) to the basic configuration 701 via the bus/interface controller 740. Example output interfaces 760 may include a graphics processing unit 761 and an audio processing unit 762, which may be configured to communicate to various external devices such as a display or speakers via one or more A/V ports 763. Example peripheral interfaces 760 may include a serial interface controller 771 or a parallel interface controller 772, which may be configured to communicate with external devices such as input devices (e.g., keyboard, mouse, pen, voice input device, touch input device, etc.) or other peripheral devices (e.g., printer, scanner, etc.) via one or more I/O ports 773. An example communication interface 780 includes a network controller 781, which may be arranged to facilitate communications with one or more other computing devices 790 over a network communication via one or more communication ports 782. A communication connection is one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

Computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 700 may also be implemented as a personal computer including both laptop computer and non-laptop computer configurations. In addition, computing device 700 may be implemented as part of a wireless base station or other wireless system or device

It should be appreciated after review of this disclosure that it is contemplated within the scope and spirit of the present disclosure that the claimed subject matter may include a wide variety coffee brewing methodologies and approached. Accordingly, the claimed subject matter is not limited in these respects.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussion utilizing terms such as “processing,” “computing,” “calculating,” “determining” or the like refer to actions or processes of a computing device that manipulates or transforms data represented as physical electronic or magnetic quantities within memories, registers, or other information storage devices, transmission devices, or display devices of the computing device.

Claimed subject matter is not limited in scope to the particular implementations described herein. For example, some implementations may be in hardware, such as those employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon that, when executed by a computing device such as a computing system, computing platform, or other system, for example, may result in execution of a processor in accordance with claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skilled in the art in light of this disclosure. In addition, those skilled in the art will appreciate that the mechanisms of the subject matter described herein are capable of being distributed as a product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter is not limited to the particular examples disclosed, but that such claimed subject matter also may include all implementations falling within the scope of the appended claims, and equivalents thereof.

What is claimed is:

1. A method of preparation of coffee, the method comprising:
roasting coffee beans to a predetermined roasting level resulting in a roasted coffee beans;
grinding the roasted coffee beans to a predetermined coarseness resulting in a ground coffee;
transferring the ground coffee to a brewing container;
providing water at a first predetermined temperature to the brewing container having the ground coffee resulting in a water and ground coffee mixture;
agitating the water and ground coffee mixture for a predetermined period of time and at a second predetermined temperature resulting in a brewed coffee mixture;
filtering the brewed coffee mixture through a first filter, the first filter comprising a metallic filter resulting in a first filtered coffee;
filtering the first filtered coffee through a second filter, the second filter comprising a fiber based filter resulting in a second filtered coffee;
filtering the second filtered coffee through a third filter, the third filter comprising a pressure plate filter resulting in a third filtered coffee; and
freeze drying the third filtered coffee resulting in a freeze dried coffee configured to be reconstituted.

2. The method of claim 1 further comprising exposing at least one of the roasted coffee beans, the ground coffee, the water and ground coffee mixture, the brewed coffee mixture, the first filtered coffee, the second filtered coffee, or the third filtered coffee to an inert gas.

3. The method of claim 1, wherein roasting the coffee beans comprises roasting raw coffee beans having organic designation standard/certification.

4. The method of claim 1, wherein roasting the coffee beans comprises roasting the coffee beans to a medium degree.

5. The method of claim 4, wherein roasting coffee beans to the medium degree comprises roasting the coffee beans to a full City Roast.

6. The method of claim 1, wherein grinding the roasted coffee beans to a predetermined coarseness comprises griding the roasted coffee beans at a coarse grind setting using a burr wheel grinder machine.

7. The method of claim 1, wherein transferring the ground coffee to a brewing container comprises transferring the ground coffee to an approximately 165 gallon brewing container.

8. The method of claim 1, wherein providing water at a first predetermined temperature to the brewing container comprises providing cold water from a tap of a public water system.

9. The method of claim 8, wherein providing cold water from a tap of a public water system comprises providing cold tap water from the public water system of Baker City, Oregon.

10. The method of claim 1, wherein agitating the water and ground coffee mixture for a predetermined period of time and at a second predetermined temperature comprises agitating the water and ground coffee mixture for 24 hours and at room temperature.

11. The method of claim 10, wherein the room temperature comprises a temperature between 60 degrees and 70 degrees Fahrenheit.

12. The method of claim 1, wherein agitating the water and ground coffee mixture for a predetermined period of time and at a second predetermined temperature comprises agitating the water and ground coffee mixture using a motor and an agitator integrated with the brewing container.

13. The method of claim 1, wherein filtering the brewed coffee mixture through a first filter comprises filtering the brewed coffee mixture through a mesh filtered integrated with the brewing container.

14. The method of claim 1, wherein filtering the first filtered coffee through a second filter comprises pumping the first filtered coffee through a 1 inch hose to the second filter.

15. The method of claim 1, wherein filtering the first filtered coffee through a second filter comprises the second filter being a tall stainless steel cylindrical file having a micro fiber sock filter.

16. The method of claim 1, wherein filtering the second filtered coffee through a third filter comprises filtering the second filtered coffee through a wine filter.

17. The method of claim 16, wherein filtering the second filtered coffee through the wine filter comprises filtering the second filtered coffee through the wine filter having 20×20 cm filter pads facilitating a flow rate between approximately 10 and 15 gallons.

18. The method of claim 1 further comprising distilling the third filtered coffee to approximately 22 percent of its original volume.

19. The method of claim 1 further comprising applying a reverse osmosis process to the third filtered coffee to approximately 50 percent concentration.

20. The method of claim 1 further comprising packaging the freeze dried coffee reconstitute at a ratio of approximately 1 teaspoon to approximately 12 ounces of hot or cold water.
